(19) United States
(12) Patent Application Publication
(10) Pub. No.: US 2011/0146358 A1
(43) Pub. Date: Jun. 23, 2011

(54) ANTI-THEFT DEVICES FOR PORTABLE DEVICES SUCH AS LAPTOPS

(76) Inventor: Meir Avganim, M.P. Nachal Sorek (IL)

(21) Appl. No.: 13/001,005

(22) PCT Filed: Jun. 28, 2009
(86) PCT No.: PCT/IL09/00637

§ 371 Date: Feb. 17, 2011

(30) Foreign Application Priority Data
Jun. 30, 2008 (IL) 192530

(51) Int. Cl. E05B 73/00

(52) U.S. Cl. 70/58; 403/291

(57) ABSTRACT

A locking device (10) for securing a portable object to an immovable object (18) by a cable (16). The locking device comprises at-least two simultaneously rotatable T-shaped heads (24a; 24b), adapted to be inserted through at-least two complementary slots (22a; 22b) formed in a side wall (20) of the portable object and rotated by about 900 in the inserted position thus preventing the separation of the device from said side-wall. The slots extend in parallel or non-parallel directions.

### FIELD OF THE INVENTION

The present invention generally relates to security devices, and specifically to lockable devices of the type comprising a lock-body arrestable against a dedicated slot formed in a side-wall of the protected object, such as a portable computer, and a cable connect at one end to the lock-body whereas the other end is adapted to be tied to an immovable object such as a table leg.

### BACKGROUND OF THE INVENTION

Locks of the type above referred to are widely used. The most popular models are known in commerce as “KENSINGTON” locks (see for example U.S. Pat. Nos. 7,100,403, 7,111,479 and many others.)

These locks suffer, however, the following inherent deficiency: Since the operation is based on a T-shaped tip or head, which is adapted to be inserted into an elongated slot formed (by the manufacturers) in a side-wall of the portable computer and then turned by 90° to prevent the extraction thereof, an auxiliary, immobilizing mechanism must be installed to prevent the rotation of the lock-body proper when the tip is in the inserted, locking position. This mechanism is necessarily quite complicated, which accordingly reflects on the manufacturing costs as well as their durability.

It is therefore the prime object of the invention to overcome this drawback of the conventional locking devices.

It is a further object of the invention to altogether dispense with the auxiliary mechanism.

It is a still further object of the invention to base the operation of the novel lock on more than a single dedicated slot.

### SUMMARY OF THE INVENTION

Provided according to the invention is an anti-theft arrangement for securing a portable object to an immovable object by a cable fastened at one end thereof to a key-operated locking device adapted to become selectively locked against, and unlocked from, a side-wall of said portable object. A first pair of slots are formed in the side-wall. A lock body is provided having a flat wall formed with a second pair of slots configured to overlap the first pair of slots. The locking device being accommodated within lock body. The locking device comprises a pair of elements having a stem and a T-shaped head, each head being adapted to project through one of said second pair of slots, by a distance exceeding the width of said side-wall. The stems extend parallel to each other. Further comprised is a rotor rotable by a key into a first, locked position and a second, unlocked position. Means are further provided for coupling the said stems to the rotor for rotating both stems in unison and for securing one end of said cable to the said body.

In one preferred embodiment of the invention, the said rotor forms a part of a push-button type lock installed at a side of said body opposite the slotted wall thereof.

Preferably, the stems extend each from one of a pair of meshing gear-wheels, one of the gear-wheels being coupled to said rotor.

The T-shaped heads may extend in crossing or in parallel directions.

### BRIEF DESCRIPTION OF THE DRAWINGS

These and additional constructional features and advantages of the invention will become more clearly understood in the light of the following description of several preferred embodiments thereof given by way of example only, with reference to the attached drawings, wherein

FIG. 1a is a general perspective view of a lock, designed according to the principles of the present invention, in the locking position thereof;

FIG. 1b shows one example of a double-slot arrangement;

FIG. 1c shows a second example of a double-slot arrangement;

FIG. 1d shows a third example of a double-slot arrangement;

FIG. 2a illustrates a position prior to mounting the lock to a computer side-wall;

FIG. 2b illustrates the locking position of the lock of FIG. 2a;

FIG. 3 is a schematic cross-sectional view of a lock body according to a first preferred embodiment of the present invention;

FIG. 4 is a sectional view taken along line IV-IV of FIG. 3;

FIG. 5 is a sectional view taken along line V-V of FIG. 3;

FIG. 6 is an exploded view of a lock body according to another embodiment of the present invention; and

FIG. 7 is a mirror image of FIG. 6 (rotated by 90°).

### DETAILED DESCRIPTION OF THE PREFERRED EMBODIMENTS

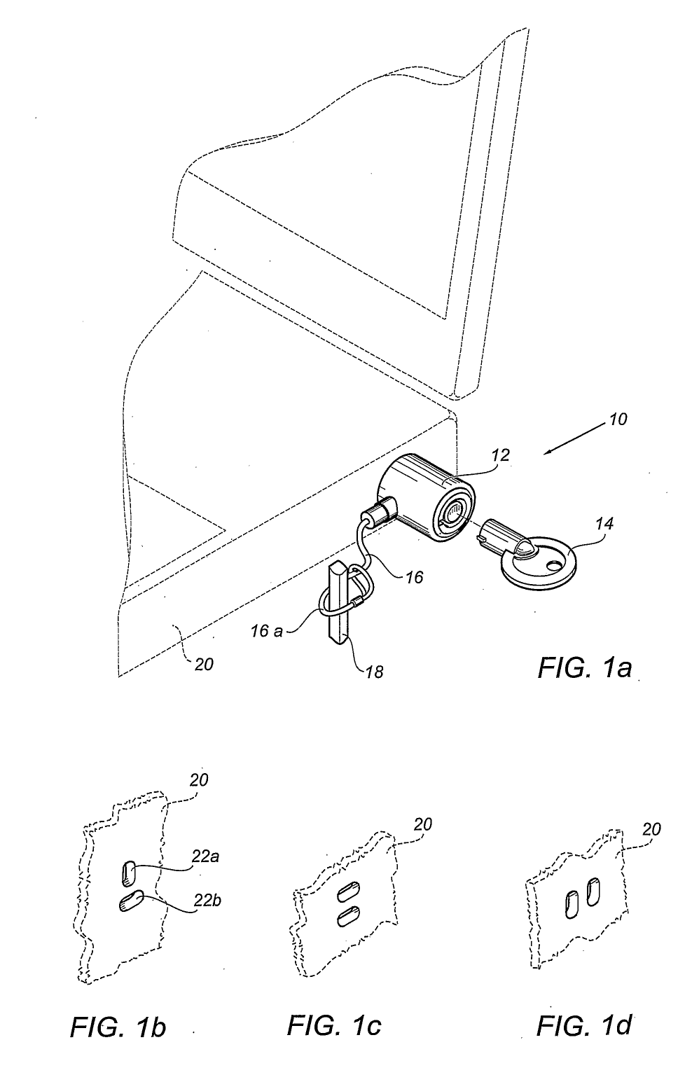

In FIG. 1a, the lock body generally designated 10 comprises a cylindrical housing 12, accommodating a locking mechanism of the push-button type, operable by key 14. Affixed to the housing 12 is one end of a security, usually steel cable 16 with a looped end 16a by which it can be tied around a fixed object such as table leg 18.

The lock is locked against side wall 20 of a laptop as shown in phantom lines. Unlike the conventional arrangements, which comprise a single security dedicated slot, there are provided a pair of slots 22a and 22b extending either in crossing direction (FIG. 1b) or in parallel—FIGS. 1c and 1d.

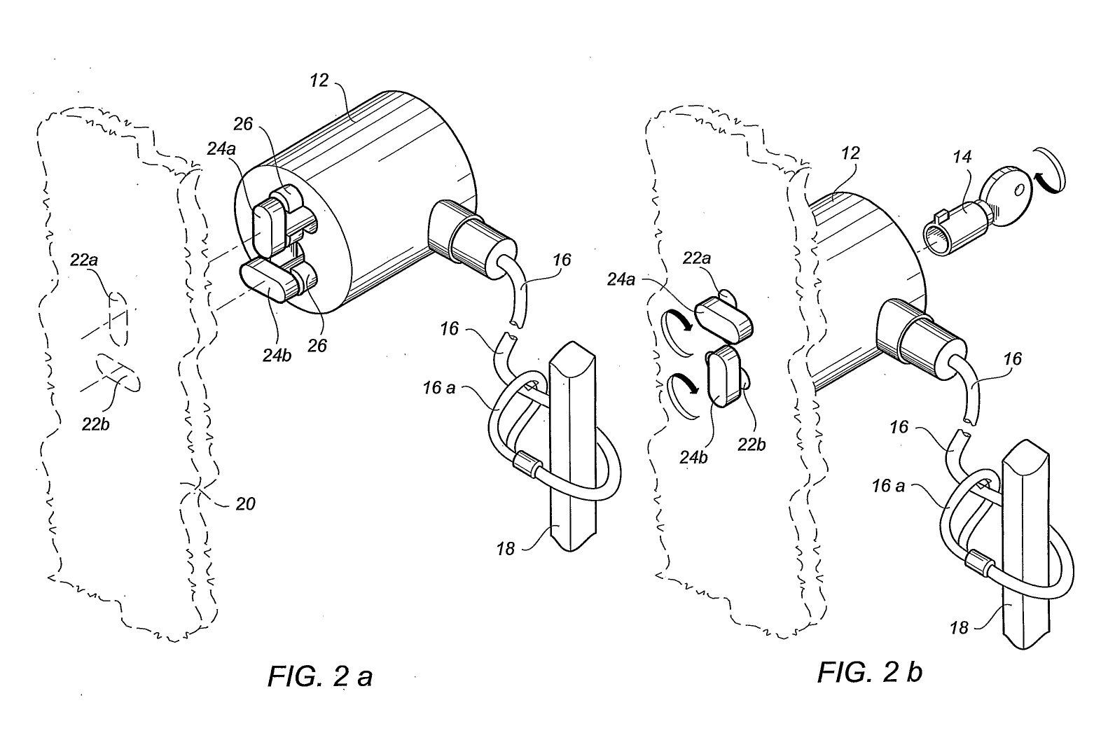

As shown in greater detail in FIGS. 2a and 2b, the locking of the lock-body 12 to the wall 20 is perfected intermediate the slots 22a and 22b, by a pair of T-shaped heads 24a and 24b, that fit respectively into and through the slots. A mechanism operated by the key 14 is adapted to rotate the heads (either in the same or in opposite directions—see for more details below) by 90° to complete the locking operation as shown in FIG. 2b.

For enhancing the stability of the locked engagement, shallow protrusions 26 underlying the heads may be included (see more clearly in FIG. 7).

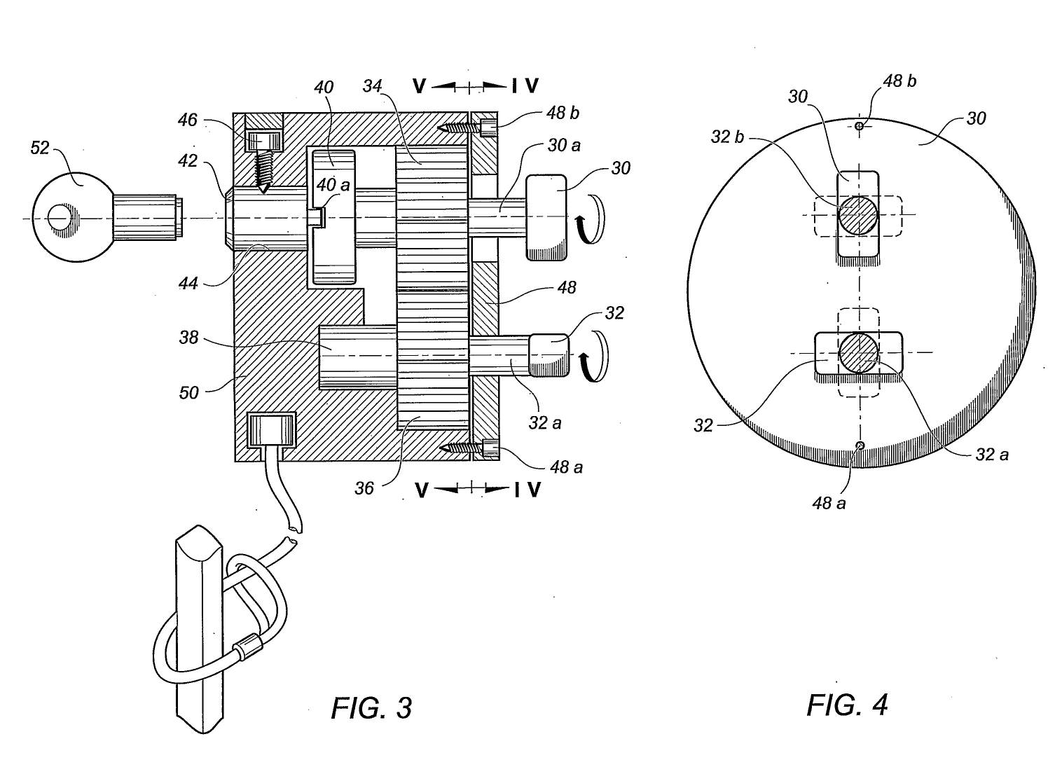

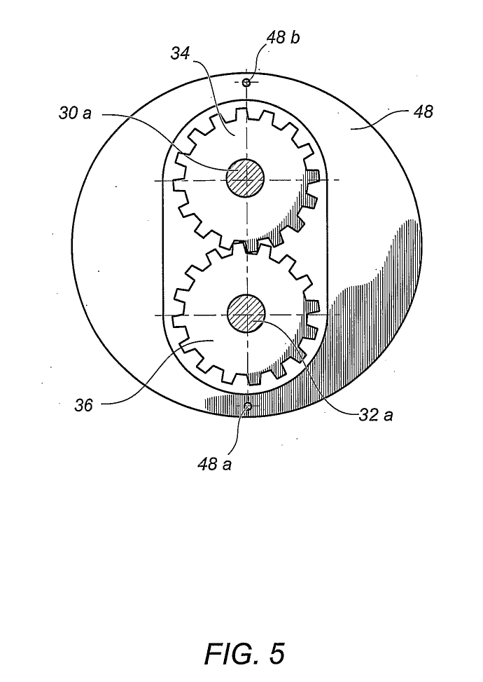

An example of a heads driving mechanism is given in FIGS. 3-5. A normally vertical extending head 30 with stem 30a, and a horizontal head 32 with stem 32a, are affixed to meshing gear-wheels 34 and 36, respectively. Gear-wheel 36 is idle, rotatably supported by axle 38. Gear-wheel 34 carries a cylindrical portion 40, which is formed with a screw -driver slot 40a by which it is coupled to the rotor (not shown) of the push-button lock body 42, the latter being secured in bore 44 by set-screw 46 in the conventional manner. Cover 48 closes housing 50, as by screws 48a and 48b.

The operation of the lock, by key 52, is readily understood in view of the foregoing description given in conjunction with FIGS. 1 and 2 above.

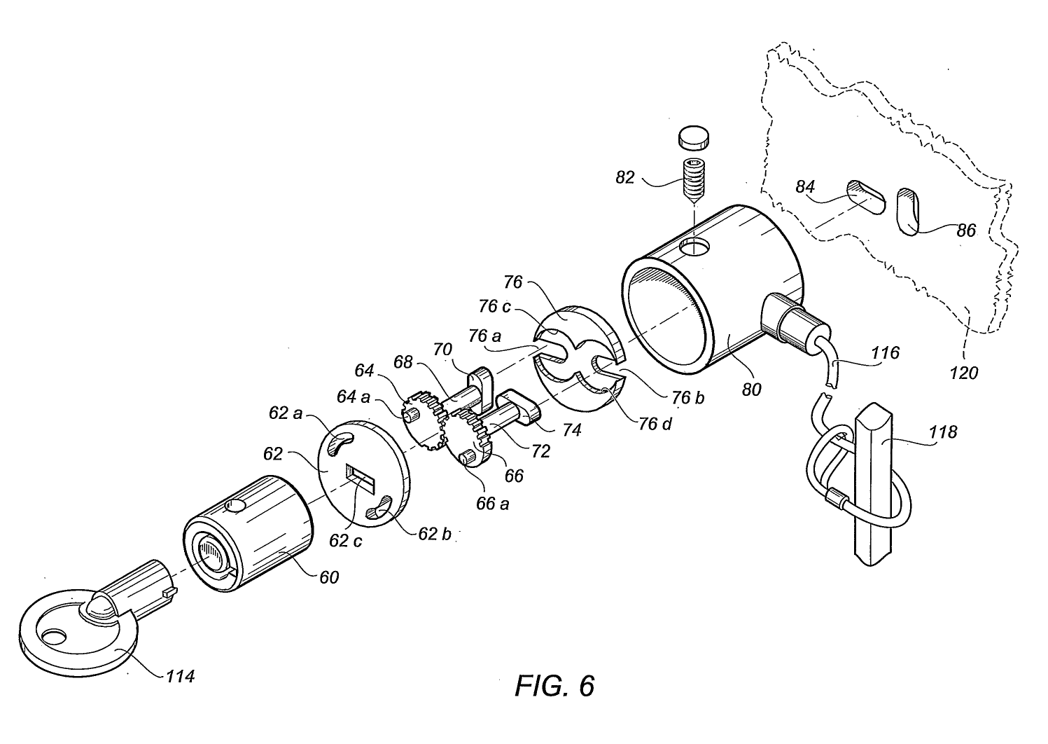

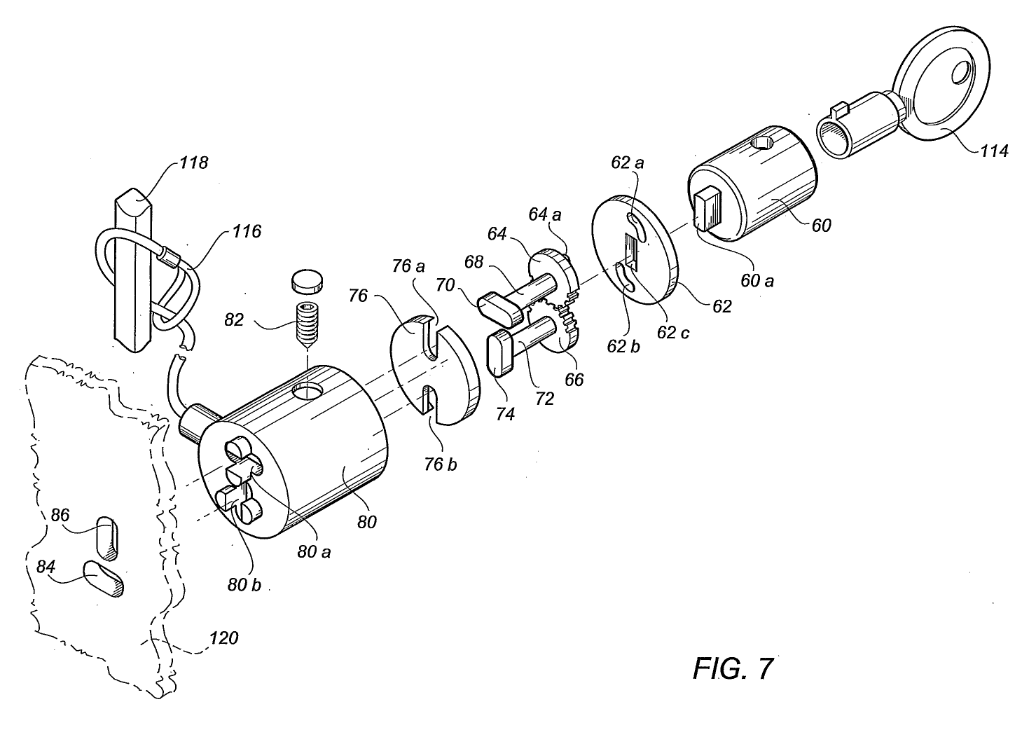

FIGS. 6 and 7 exemplify a modified tip-driving mechanism, which differs from the preceding embodiment only by using certain other mechanical components. Hence, push-button lock body 60 is coupled to a first disk 62 by its rotable detent 60a fitting into the slot 62c. The disc 62 is coupled to eccentric pins 64a and 66a of gears 64 and 66 by slots 62a and 62b, respectively. Preferably, the gears are only partly toothed, in order to limit the rotation thereof (in both directions) along a pre-set angle (90°) for the convenience of the user, namely, automatically indicating the “OPEN” and the “CLOSED” positions of the locking device.

In the assembled state, namely accommodated in housing 80, the heads 70 and 74 are passed through slots 76a and 76b formed in disc 76, while the gears 64 and 66 become rotatively supported by shallow, circular depressions 76c and 76g formed in the second disc 76. The tips 70 and 74 further extend through respective slots 80a and 80b formed in the front, planar wall of the lock housing 80 to such extent as to pass, in the mounted position of the lock, also through slots 84 and 86 of the protected object wall 120.

As in the former embodiment, the locking of the housing 80 against wall 120 is perfected by rotating the heads 70 and 74 by 90° behind the wall 120, namely when the disc 62 is rotated by the detent 60a using the key 114.

It will be thus clearly seen that locking devices designed according to the principles of the present invention are of a most simple construction, involving a minimum number of moving parts and hence less costly in production and of a more reliable operation.

Those skilled in the art to which this invention pertains will readily appreciate that numerous changes, variations and modifications can be effectuated without departing from the true spirit and scope of the invention as defined in and by the appendent claims.

What is claimed is:

1. An anti-theft arrangement for securing a portable object to an immovable object by a cable fastened at one end thereof to a key-operated locking device adapted to become selectively locked against, and unlocked from, a side-wall of said portable object, the arrangement comprising:
A. A first pair of slots formed in said side-wall;
B. a lock body having a flat wall formed with a second pair of slots configured to overlap the said first pair of slots;
C. said locking device being accommodated within said lock, body, the device comprising:
a pair of elements having each a stem and a T-shaped head, each head projecting through one of said second pair of slots by a distance exceeding the width of said side-wall, said stems extending parallel to each other;
a rotor rotatable by a key into a first, locked position and a second, unlocked position;
means for coupling the said stems to the rotor for rotating both stems in unison; and
D. means for securing one end of said cable to the said lock body.

2. The arrangement as claimed in claim 1, wherein the said rotor forms a part of a push-button type lock installed at a side of said lock body opposite the said flat wall thereof.

3. The arrangement as claimed in claim 2, wherein each of the said stems extend from one of a pair of meshing gear-wheels, at least one of the gear-wheels being coupled to said rotor.

4. The arrangement as claimed in claim 3, wherein the said T-shaped heads extend in crossing directions,

5. The arrangement as claimed in claim 3, wherein the said T-shaped heads extend in parallel directions.

6. The arrangement as claimed in claim 2, wherein one of the gear-wheels is coupled to the said rotor and the other is freely rotatable.

7. The arrangement as claimed in claim 6, wherein said one gear-wheel is coupled to the rotor by a rotatably supported cylindrical member axially connected to the gear-wheel.

8. The arrangement of claim 1, wherein each of said pair of elements comprises a gear-wheel mounted to said stem at the side opposite to the T-shaped head, meshing with each other and carrying driving pins, the driving pins being coupled to a first disc drivingly coupled to said rotor.

9. The arrangement as claimed in claim 8, wherein said driving pins are eccentrically mounted to a surface of their respective gear-wheels.

10. The arrangement as claimed in claim 9, wherein the gear-wheels are rotatively supported by a second disc.

11. The arrangement as claimed in claim 10, wherein the gear-wheels are seated within shallow circular cavities formed in a surface of said second disc.

12. A locking device for securing a portable object to an immovable object by a cable, the locking device comprising at-least two simultaneously rotatable T-shaped heads, adapted to be inserted through at-least two complementary slots formed in a side wall of the portable object and rotated by about 90° in the inserted position thus preventing the separation of the device from said side-wall.

13. The locking device as claimed in claim 12, wherein the said slots extend in parallel directions.

14. The arrangement as claimed in claim 12, wherein the said slots extend in non-parallel directions.

15. The arrangement as claimed in claim 12, wherein the T-shaped heads are each extended by a stem with meshing gear-wheels configured to impart simultaneous rotational movement to the T-shaped heads.

16. The arrangement as claimed in claim 15, wherein the said rotational movement is generated by a key-operated locking mechanism.

17. The arrangement as claimed in claim 16, wherein the key-operated locking mechanism is drivingly coupled to at-least one of said gear-wheels.
